(19) United States
(12) Patent Application Publication
(10) Pub. No.: US 2011/0073743 A1
(43) Pub. Date: Mar. 31, 2011

(54) Universal holder and flexible member for mounting, holding and adjustably positioning electronic products and accessories

(76) Inventor: Steven Shamie, Brooklyn, NY (US)

(21) Appl. No.: 12/928,047

(22) Filed: Dec. 2, 2010

Related U.S. Application Data
(63) Continuation-in-part of application No. 12/661,571, filed on Mar. 19, 2010.
Application No. 12/661,571 is a continuation-in-part of application No. 12/454,138, filed on May 13, 2009, now abandoned.

(51) Int. Cl. F16M 13/00

(52) U.S. Cl. 248/537

(57) ABSTRACT

A universal holder and flexible member for mounting, holding and adjustably positioning hand-held electronic devices and accessories which includes a device gripper for retaining the electronic device. The device holder is attached to a gooseneck arm, the gooseneck arm being flexible, yet rigid enough to support the weight of the electronic device in a predetermined configuration. The gooseneck is modular, i.e. comprised of shorter modular segments that can be screwed together to form a longer gooseneck of a chosen length. The universal holder may be secured to the wall mount bracket for a TV, a windshield, shelf, wall, treadmill, bench, pole, pane of glass, automobile cigarette lighter, tabletop, or the like through employment of one of a selection of terminations. The selection of terminations includes a lug, a suction cup, a clip, a automobile cigarette lighter plug, and a desk-top base.

### CROSS REFERENCE TO RELATED APPLICATION

This application is a continuation in part of the application filed by the same applicant having a Ser. No. 12/661,571 and a filing date of Mar. 19, 2010 which in turn is a continuation in part of the application bearing Ser. No. 12/454,138 and a filing date of May 26, 2009.

### FIELD OF THE INVENTION

The present invention is a universal holder for mounting and positioning hand held electronic products and accessories. More specifically, the present invention holder includes a gripping device holder having a selection of terminations to retain a hand-held electronic product, which device holder is attached to a modular, flexible gooseneck.

### BACKGROUND OF THE INVENTION

Previously disclosed in the parent applications were inventions directed at a universal holder for securing and positioning electronic products and accessories. The present invention improves on the previously disclosed invention in several ways. The present invention is specifically for use with all hand-held electronic devices such as media players, tablet PC's, portable tv's, PDA's, cellular telephones, remote controls, GPS devices, etc. The object of the present invention is to provide a universal holder and flexible gooseneck for holding securing and positioning any hand-held electronic device. Once in place, it will securely hold and/or provide for the connecting of all manners of hand-held or similarly-sized electronic devices, such as media players, tablet PC's, portable tv's, PDA's, cellular telephones, remote controls, GPS devices, and the like.

Use of three very versatile components makes usage of the present invention universal: 1) the selection of interchangeable mounting terminations which include a lug, suction cup, desk top base, automobile cigarette lighter plug in, and a spring loaded clip, 2) the flexible modular gooseneck arm, and 3) the gripping device holder for securing the electronic product. For example, the mounting lug can be selected and attached to the end of the gooseneck. If one wants to connect any hand-hand electronic product to a TV, he may choose to bolt the lug of the present invention directly to a TV wall bracket or screw it into the wall behind the TV. If one wants to connect or hold one of the electronic products adjacent to a computer, it can be easily bolted or screwed into any piece of furniture such as a desk, or the clip or the desk top base may be employed. And, it can also be screwed into a nightstand to conveniently hold a TV remote, PDA or cell phone. This would aid in the prevention of remote controls from being lost or misplaced. And since a device such as a remote control or PDA can be placed in the gripping device holder of the present invention, it no longer need be placed on the surface of the night table. This aids in the reduction of clutter and adds more usable space. In addition, this makes viewing and charging the device easier. Further, one no longer needs to pick up the cell phone to see who is calling. Now, when a phone call comes in, a glance replaces the need to actually pick up the phone by hand to see who the caller is.

In addition, the newly disclosed embodiment of the present invention offers a selection of terminations that will make it usable almost anywhere because it can mount to almost anything. It can be utilized for attachment to a TV wall mount bracket, the wall, a shelf, a dashboard, a automobile cigarette lighter, a tabletop, a windshield or any pane of glass, a tray table, a computer monitor, treadmill, etc. The newly disclosed terminations offers a choice to use the lug to attach the universal holder employing a screw, as previously disclosed. However, newly disclosed are a suction cup termination for attachment of the device to a windshield or a pane of glass, a clip termination which can be utilized to attach the device to a shelf or the like, a cigarette lighter termination for insertion into an automobile cigarette lighter and a desk top base.

By way of further background, if one wants to connect any hand-held electronic device, he can select and attach the lug to the end of the gooseneck and bolt it either to a wall or to a tv wall bracket behind the tv. If one would like to use a hand-held electronic device in a car, he has two choices: he can select and attach the suction cup termination and mount the device to the windshield or another glass surface or if he would like the device closer to his dash board then he can use the lighter attachment. For office use, a person may select and attach the desk top base which would allow the user to keep the electronic device up near a computer monitor. The clip can be utilized to attach a hand-held electronic device to a shelf, a treadmill, airline tray tables, park benches, poles and the like.

Moreover, since the present invention utilizes a flexible gooseneck member and a universal holder, it is an object of the present invention that any hand-held electronic product can be mounted, held, adjustably positioned, accessed and utilized almost anywhere. For example, the present invention can be attach a hand-held electronic device around the periphery of a TV, to a desk, in car to the windshield and/or to the dashboard of a car while traveling, or to an automobile's cigarette lighter. Hand-held electronic products such as media players, tablet PC's, portable tv's, PDA's, cellular telephones, remote controls, GPS devices, and the like, can be securely held and adjustably positioned and accessed at home, at work, while traveling, and can be used adjacent to a tv, a computer, on a desk or table, to a treadmill, in the car, etc. Moreover, in the newly disclosed embodiment of the present invention, the gooseneck arm is modular, i.e. is comprised of individually modules of shorter gooseneck which may be screwed together to make a longer length gooseneck of a chosen length. As such, even greater flexibility is afforded regarding the positioning of the electronic device. For example, one may choose to use the invention to mount, hold and connect a remote control at the top of the TV screen. Another example of the employment of the gooseneck is for use in a truck or large vehicle with a large windshield; a driver may use multiple sections of gooseneck to position a hand-held electronic device closer to him.

Other objectives, advantages and novel features, and further scope of applicability of the present invention will be set forth in the detailed description to follow, taken in conjunction with the accompanying drawings, will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a universal holder and flexible member for mounting, holding and adjustably positioning hand-held electronic devices and accessories. The universal holder of the present invention includes a device gripper for retaining the electronic device, the device gripper arms ratchet or are adjustable horizontally or vertically to grip the electronic device or to apply constant negative pressure to grip. The device holder is attached to a gooseneck arm, the gooseneck arm being flexible, yet rigid enough to support the weight of the electronic device in a predetermined configuration. The gooseneck is formed from metal, plastic or a combination of materials. The gooseneck is modular, i.e. comprised of shorter modular segments that can be screwed together to form a longer gooseneck of a chosen length. The universal holder of the present invention may be secured to the wall mount bracket for a TV, a windshield, a shelf, a wall, a pane of glass, a cigarette lighter of an automobile, a tabletop, or the like through employment of one of a selection of terminations. The selection of terminations includes a lug, a suction cup, a clip, a automobile cigarette lighter plug, and a desk-top base which may be disc-shaped or square.

### BRIEF DESCRIPTION OF THE FIGURES

For a better understanding of the present invention, reference is made to the following description of an exemplary embodiment thereof, considered in conjunction with the accompanying drawings, in which:

FIG. 1 is a perspective view of the universal holder as previously disclosed in the parent applications.

FIG. 1A is a perspective view of the modular gooseneck of the present invention universal holder.

FIG. 1B is a perspective view of the gooseneck of the present invention universal showing it in a bent configuration.

FIG. 2 is a exploded view of the present invention universal holder showing a selection of various terminations.

FIG. 3 is a perspective view of the present invention universal holder showing the newly disclosed device holder having curvilinear side walls.

FIG. 4 is an elevational view of the present invention universal holder having the suction cup termination attached to the windshield of a vehicle.

FIG. 5 is a perspective view of the present invention universal holder having the clip termination attached to a shelf.

FIG. 6 is perspective view of the present invention universal holder having the clip termination attached to a shelf and depicting the gooseneck bent into a curved configuration.

FIG. 7 is an exploded view of the present invention universal holder showing it in position to be attached to the wall-mount bracket of a flat-screen television.

FIG. 8 is an exploded view of the present invention universal holder showing the gooseneck's male threads in position to be attached to the lug termination having female threads.

FIG. 9 is a depiction of the present invention universal holder with the cigarette lighter termination showing its insertion into an automobile cigarette lighter.

FIG. 10 is a depiction of the two embodiments of the present invention with the desk top support termination shown in use on a desk.

### DETAILED DESCRIPTION OF THE INVENTION

The present invention is a universal holder and flexible member and interchangeable mounting system for mounting, holding and adjustably positioning hand-held electronic products and accessories. Utilizing the universal holder of the present invention, a user is enabled to adjustably mount an electronic product or other such device to the wall-mount bracket of a typical flat-screen television. Alternatively, the present invention universal holder of the present invention may be utilized to adjustably mount an electronic product or other such device to an article of furniture, to a wall, to the dashboard of a vehicle, windshield or another pane of glass, placed on a tabletop, attached to the cigarette lighter of an automobile, or the like. The universal holder of the present invention is typically employed to adjustably mount and position media players, tablet PC's, portable tv's, PDA's, cellular telephones, remote controls, GPS devices, and the like.

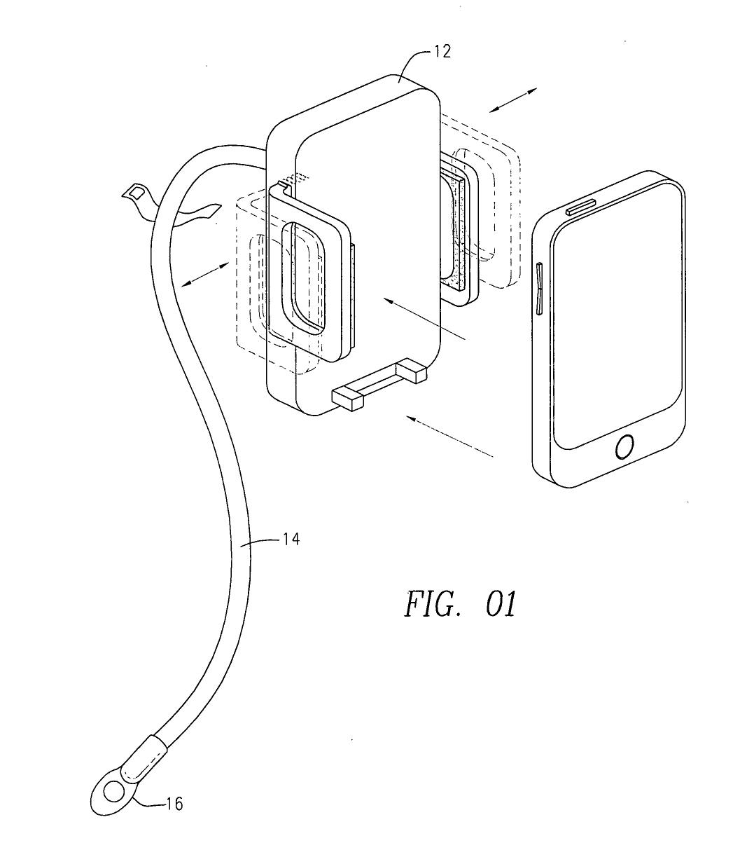

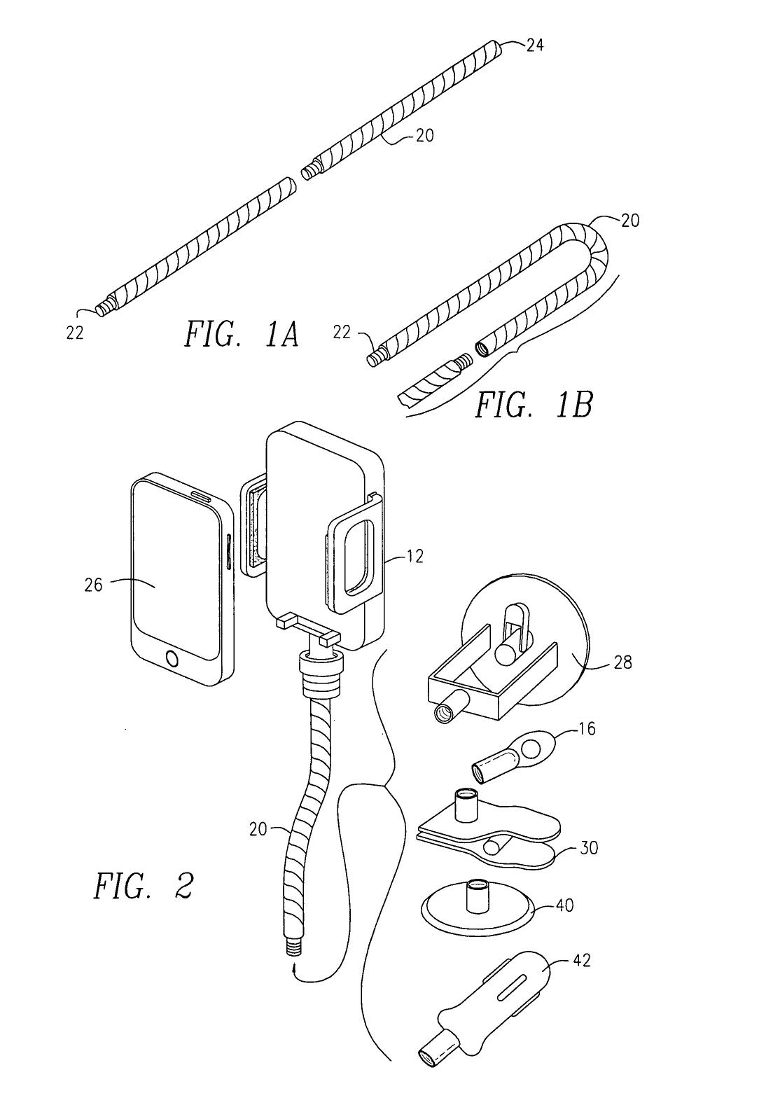

A representative example of one embodiment of the device previously disclosed by the applicant in the parent applications (an embodiment for use with hand-held electronic devices) is shown in FIG. 1. As shown in this previously disclosed embodiment, the device is a universal holder and flexible member for holding and positioning electronic products, accessories or the like relative to a television, wall or piece of furniture. The device disclosed comprises the device holder 12 which grips the electronic device. The device holder, as previously disclosed in the embodiment shown, is generally u-shaped thereby permitting insertion of an electronic product or the like within the interior of the U. The arms of the device holder ratchet horizontally and/or vertically in order to permit a user to adjust the position its arms around the electronic device and thereby firmly retain the electronic device.

Further included in the previous disclosure is a gooseneck connecting arm 14. The gooseneck connecting arm, as previously disclosed, is flexible, yet sturdy enough to retain a chosen configuration. As such, the user can bend or flex the gooseneck arm of the invention to the configuration chosen, and it will support the weight of the retained electronic product or accessory without deforming from the chosen configuration. The gooseneck arm is removably attached to the device holder 12 on one end. At the other end of the goose neck arm is attached a lug 16. The lug, as shown, is oval-shaped and includes a screw-hole at its center. The lug is utilized to screwably attach the gooseneck arm to the wall-mount bracket of a flat screen, or to a wall, piece of furniture or to any other flat surface. As such, the user screws the lug of the gooseneck arm to the location chosen, thereby securing the universal holder in place where it is ready to retain a electronic device.

Now attention is turned to the presently disclosed new aspects of the invention. Generally, as disclosed herein, the present invention universal holder which is specifically for employment with hand-held electronic devices, is improved in several ways. First, although the gooseneck arm may still be terminated with a lug, other means of termination are disclosed. Second, instead of a unitary gooseneck arm, a modular gooseneck is shown. And third, a newly designed device holder with curvilinear walls is disclosed.

Looking now at the Figures and in particular at FIG. 1A, the newly disclosed modular gooseneck arm 20 is depicted. More specifically, the newly disclosed modular gooseneck is depicted in exploded condition in FIG. 1A, Furthermore, FIG. 1B depicts one module of the gooseneck 20 shown in a bent configuration. Being modular, one, two, or more individual modules of the gooseneck arm may be connected together so that a user may select the desired length of the gooseneck. At the proximal end of each of the modules, is a screw connector 22 that has male threads. At the distal end of each of the modules is a mating female screw connector 24. It is readily understood that the individual modules may be attached together to make a longer gooseneck arm simply by screwably attaching the male screw end of one module to the female screw end of another. Furthermore, the last male screw connector of the chain of modules can be mated to the female screw end of the lug 16 or other selected termination. Finally, the last female screw connector of the chain of modules can be connected to the device holder 12.

Looking now at FIG. 2, one module of the gooseneck is shown with its male screw end attached an embodiment of the device holder 12 for retention of hand held electronic product 26. A selection of terminations is provided, each of which includes a female screw attachment for attachment to the male screw at the end of the gooseneck. Specifically, provided with the present invention are a lug 16, as previously disclosed, a suction cup 28, a clip 30 a desk top support in the shape of a disk 40, and a automobile cigarette lighter termination 42. The suction cup 28 may be utilized to attach the universal holder of the present invention to a pane of glass, a dashboard of an automobile, or the like. The clip 30 may be employed to attach the universal holder of the present invention to a shelf, piece of furniture, or any other object to the which the attachment clip can be secured. The desk top support 40 may be circular, square on another configuration so long as it has a wide enough support base so that it will support the weight of a hand-hand electronic device. The cigarette lighter termination 42 is inserted into a car's cigarette lighter so that the present invention can be utilized to support and position a media players, tablet PC's, portable tv's, PDA's, cellular telephones, remote controls, GPS devices, and the like in an automobile.

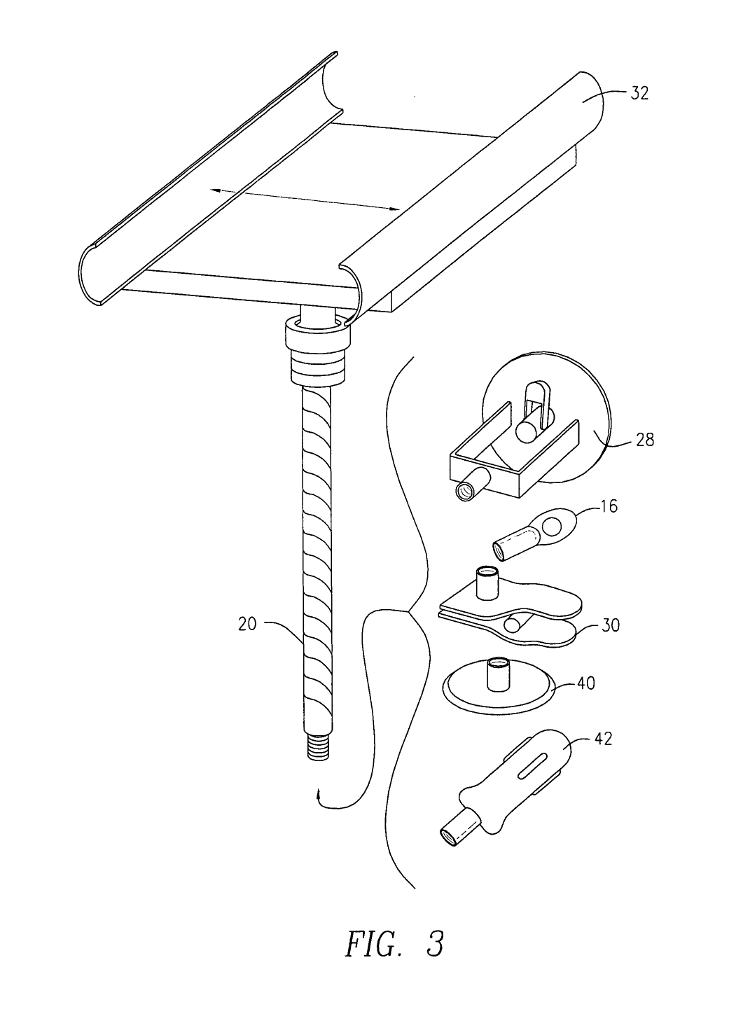

Looking at FIG. 3, the invention is shown with the gooseneck attached to a newly disclosed embodiment of the device gripper 32. The new device holder is still generally u-shaped. However, the newly designed device holder arms have curved side wall to give the holder a sleek appearance and to improve the gripping of electronic devices or the like which have curved exteriors. The device gripper firmly retains the hand-held electronic device and is adjustable in at least one direction and exerts negative pressure on the device to hold in securely in place. The gripper may be spring loaded, or ratcheting to hold the device firmly in place. As shown in FIG. 3, the newly designed holder arms are screwed to the gooseneck 20. In turn, opposite end of the gooseneck has male screw threads which are to be screwed to the selection of terminations (i.e. lug 16, suction cup 28, clip 30, table top base 40 or cigarette lighter attachment 42) as depicted.

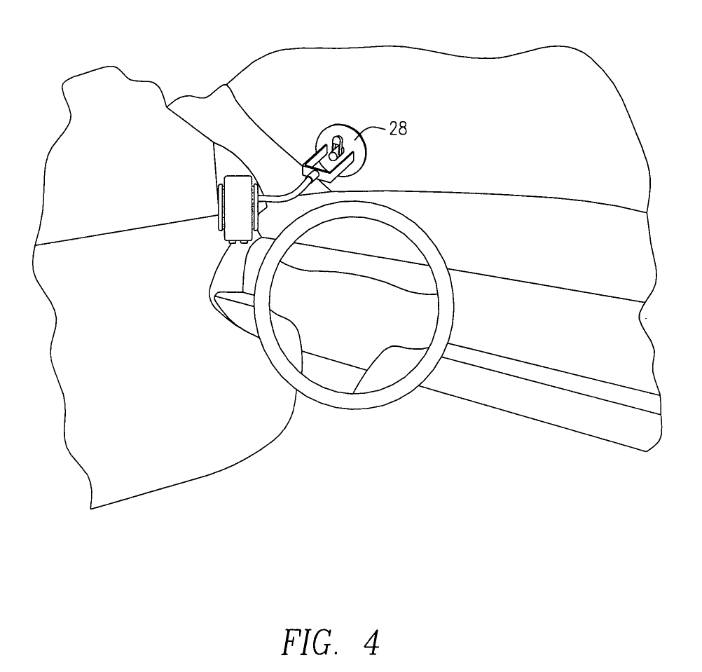

The present invention is well suited for employment in an automobile to retain any hand-held electronic devices such as media players, tablet PC's, portable tv's, PDA's, cellular telephones, remote controls, GPS devices, and the like in position for the user to see and utilize. As depicted in FIG. 4, the suction cup termination 28 of the present invention may be employed to attach the present invention to the windshield or another glass surface of a vehicle. Through selection of the appropriate number of the modules of the gooseneck the length of the gooseneck arm may be selected. Furthermore, by bending the gooseneck arm, the user may select the height and position of the electronic device being retained.

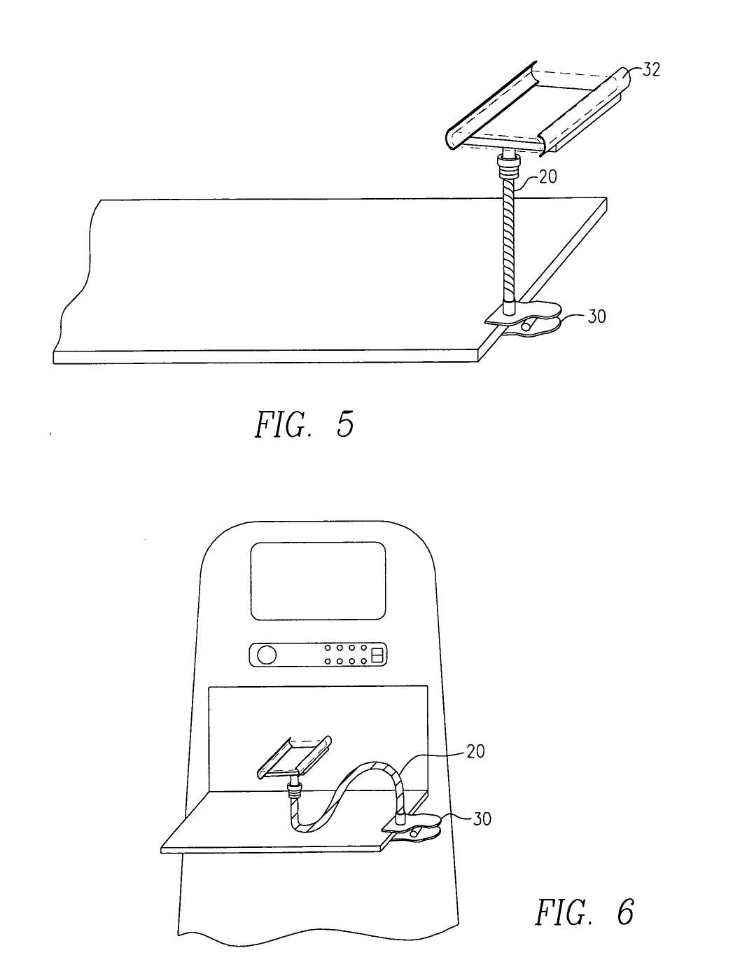

As seen in FIGS. 5 and 6, through employment of the clip 30, the universal holder of the present invention may be utilized to attach an electronic device to a shelf Through choice of this termination (clip 30) a hand-held electronic device can also be attached to a treadmill, in an airplane cockpit, park benches, poles, or to anything else to which it may be clamped using the clip. Also well depicted in FIG. 5 is the newly designed device holder showing its curvilinear arms.

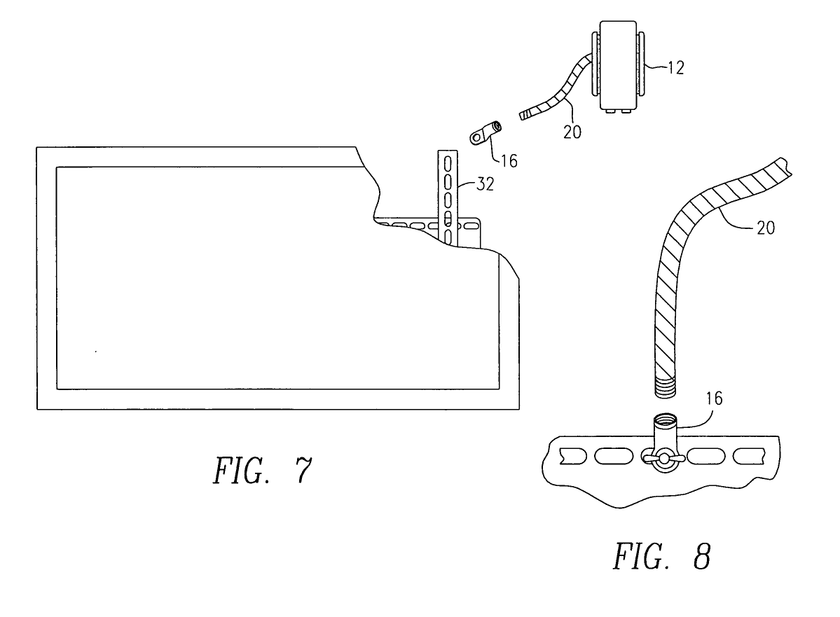

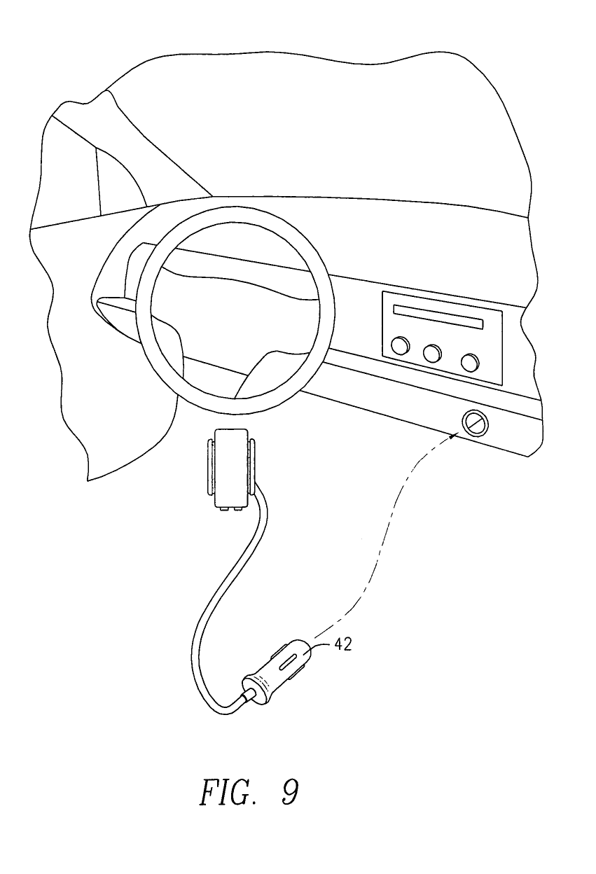

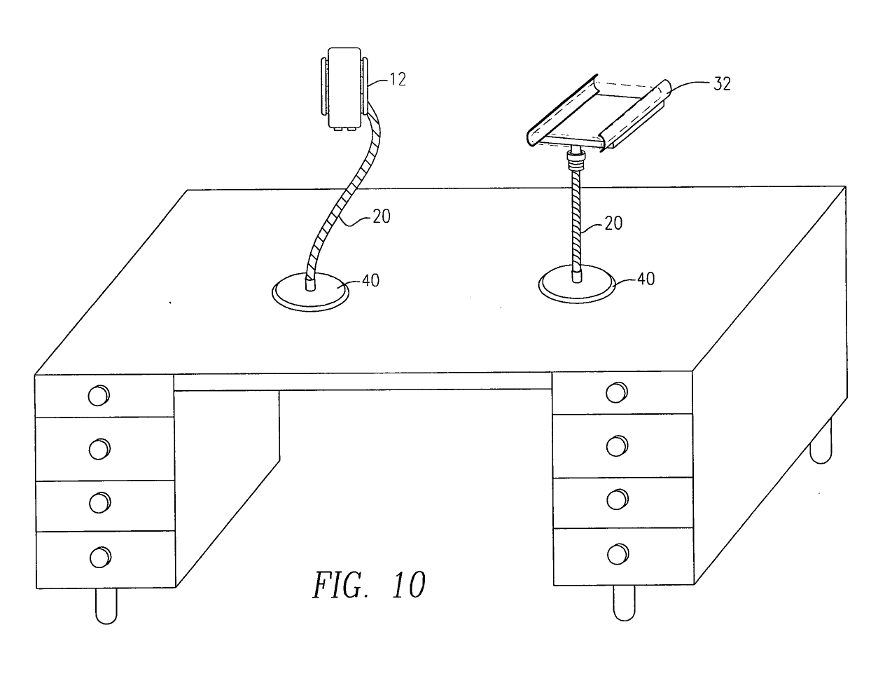

Looking at FIGS. 7 and 8, the universal device holder of the present invention can be employed to attach an electronic device to the wall-mount bracket 32 for mounting a flat screen television to a wall. In this deployment, the lug termination 16 is utilized to screw the termination to the wall mount bracket. As with other embodiments, the gooseneck is screwed to the lug termination and the gooseneck can be lengthened or shortened by selection of the appropriate number of modules. Furthermore, the position of the electronic device may be further chosen by bending the gooseneck into position.

The foregoing is considered as illustrative only of the principles and preferred embodiment of the invention. Furthermore, since numerous changes and modifications will readily occur to one skilled in the art, it is not desired to limit the invention to the exact construction, operation and embodiment shown and described, and accordingly all suitable modifications and equivalents may be resorted to, falling within the scope of the invention.

What is claimed:

1. A universal holder for mounting, holding and adjustably positioning hand-held electronic devices and accessories comprising:
a device gripper for retaining the electronic devices, said device gripper adjustable in at least one direction to apply pressure to and to firmly retain said electronic device;
a gooseneck, said gooseneck having a termination connection end and a device holder connection end, said device holder connection end attached to said device holder, said gooseneck being formed from at least one modular gooseneck segment which modular segments may be attached together to form a gooseneck of a chosen length;
and a termination attached to said termination connection end of said gooseneck, said termination chosen from a selection of terminations which includes a lug, a suction cup, a clip, a cigarette lighter attachment and a desk-top support base.
